(19) United States
(12) Patent Application Publication
(10) Pub. No.: US 2026/0251175 A1
(43) Pub. Date: Aug. 27, 2026

(54) COMBINATION BEARING ASSEMBLY WITH LOAD SEPARATION

(71) Applicant: AKTIEBOLAGET SKF, GOTEBORG (SE)

(72) Inventors: Rudolf HAULEITNER, Ann Arbor, MI (US); Hans WALLIN, Cape Coral, FL (US)

(21) Appl. No.: 19/064,847

(22) Filed: Feb. 27, 2025

(51) Int. Cl. F16C 19/54; F16C 25/08; F16C 41/00

(52) U.S. Cl. CPC F16C 19/545; F16C 19/546; F16C 25/083; F16C 41/001; F16C 2223/30; F16C 2229/00

(57) ABSTRACT

A bearing assembly for coupling a shaft with a housing includes a radial load bearing supporting radial loading between the shaft and housing and including an inner ring disposed about the shaft, an outer ring disposed about the inner ring and engaged with the housing, and cylindrical rolling elements between the inner and outer rings. An axial load bearing supports axially loading on the shaft and/or the housing and includes an inner ring disposed about the shaft, an outer ring disposed about the inner ring, and rolling elements disposed between the inner and outer rings. The outer ring has an axial surface disposed against an axial surface of a spacer ring, the radial load bearing, or a portion of the housing to define an axial interface. A layer of friction reducing material is formed on one or both axial surfaces of the interface to reduce a coefficient of friction.

### BACKGROUND OF THE INVENTION

The present invention relates to bearings, and more particularly to bearing assemblies including radial and axial bearings mounted on a common shaft.

Rolling element bearings are well known and include inner and outer rings or races rotatably coupled by a plurality of rolling elements. Certain bearings, such as cylindrical roller bearings, are typically used to support radial loading between inner and outer members (e.g., a shaft and a housing) while other bearings, for example angular contact ball bearings, are used to primarily support and transfer axial loading between the members. Depending on the particular application, the “radial load” bearings and the “axial load” bearings may be used separately or in combination.

For example, in a screw compressor, a combination of radial and axial load bearings are used to couple a rotating shaft, on which a screw is mounted, to an outer housing. Typically, the radial load bearing is a single cylindrical roller bearing and the axial load bearing(s) are one or more angular contact ball bearings. Axial loading on the shaft is transferred from the shaft to the housing through the axial load bearing(s), such that the outer ring of at least one axial load bearing must be in contact with the housing, either directly or through the radial load bearing or another component (e.g., a spacer ring).

### SUMMARY OF THE INVENTION

In an aspect, the present invention is a bearing assembly for rotatably coupling a shaft with an outer housing. The bearing assembly comprises a radial load bearing configured to support radial loading between the shaft and the housing and including an inner ring disposed about the shaft, an outer ring disposed about the inner ring and engaged with the housing, and a plurality of cylindrical rolling elements disposed between the inner and outer rings. An axial load bearing is configured to support axially loading on at least one of the shaft and the housing and includes an inner ring disposed about the shaft, an outer ring disposed about the inner ring, and a plurality of rolling elements disposed between the inner and outer rings. The outer ring has an axial surface disposed against an axial surface of a “transfer member” so as to define an axial interface, the transfer member being a spacer ring disposed between the radial load bearing and the axial load bearing, the outer ring of the radial load bearing, or a portion of the housing. Further, a layer of friction reducing material is formed on at least one of the two axial surfaces defining the axial interface so as to reduce a coefficient of friction of the axial interface.

With this arrangement, axial loading is transferred between the shaft and the housing through the axial interface, specifically axial loading on the shaft is transferred from the outer ring of the axial load bearing to the housing through the transfer member. By providing the layer of friction reducing material, the outer ring of the axial load bearing is freely slidable radially against the transfer member, such that the outer ring of the axial load bearing displaces radially when a radial load is applied to the bearing assembly. As such, the radial load is transferred between the shaft and the housing only through the radial load bearing. Thus, the friction reducing layer is configured to prevent frictional coupling of the outer ring of the axial load bearing with the transfer member, such that the radial load bearing takes all of the radial loading and only axial loading is supported by the axial load bearing, shared between two or more axial load bearings.

Preferably, the layer of friction reducing material is either a surface treatment, preferably formed by a black oxidation process conducted on at least one axial surface of the axial interface, or a coating formed of a polymeric material that is applied to the at least one axial surface of the axial interface. Further, the layer of friction reducing material preferably has a thickness within the range of one micron and fifty microns, most preferably within a range of five microns and fifteen microns.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a broken-away, axial cross-sectional view of a portion of a screw compressor, showing a bearing assembly in accordance with the present invention installed about a shaft and within a housing;

FIG. 2 is an enlarged portion of FIG. 1, showing the upper portions of four bearings of the preferred bearing assembly;

FIG. 3 is a more enlarged view of a portion of FIG. 1, showing a radial load bearing and an axial load bearing, the axial load bearing having an outer ring disposed against a spacer ring;

FIG. 4 is a more enlarged, axial cross-sectional view of the radial load bearing and the axial load bearing in which the outer ring of the axial load bearing is disposed against an outer ring of the radial load bearing; and

FIG. 5 is a more enlarged, axial cross-sectional view of the radial load bearing and the axial load bearing in which the outer ring of the axial load bearing is disposed against a portion of the housing.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

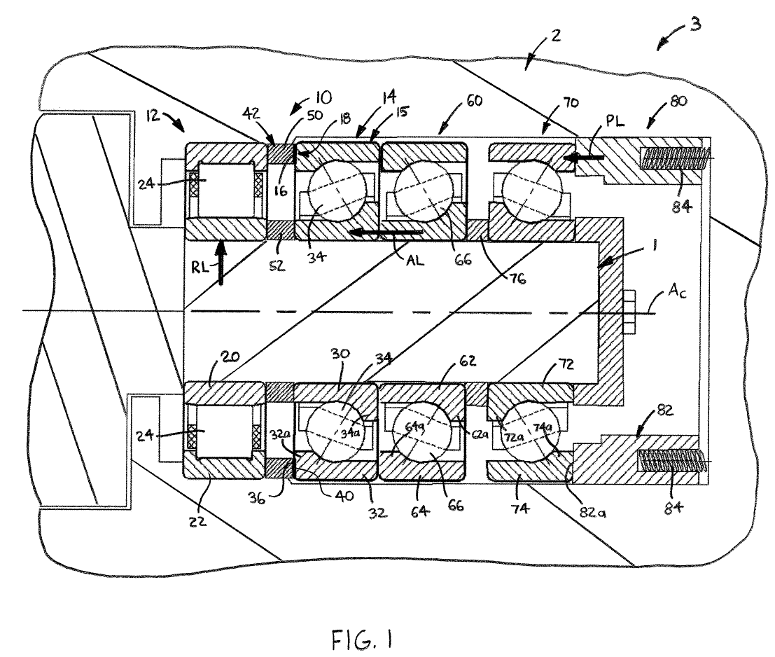

Referring now to the drawings in detail, wherein like numbers are used to indicate like elements throughout, there is shown in FIGS. 1-5 a bearing assembly 10 for rotatably coupling a shaft 1, which is rotatable about a central axis A_{C}, with an outer housing 2, the shaft 1 and the housing 2 being components of a machine 3. The machine 3 is preferably a screw compressor 3, but may alternatively be a gear box assembly (not shown) or another similar mechanical device or machine in which it is desired to separate radial and axial loading of the bearings. The bearing assembly 10 basically comprises a radial load bearing 12 configured to support radial loading RL between the shaft 1 and housing 2, at least one axial load bearing 14 configured to support axial loading AL on at least one of the shaft 1 and the housing 2, and a layer of friction reducing material 16 formed on an axial interface 18 between the axial load bearing 14 and a component fixedly coupled with the housing 2 or a portion of the housing 2, as described below.

More specifically, the radial load bearing 12 includes an inner ring 20 disposed about the shaft 1, an outer ring 22 disposed about the inner ring 20 and a plurality of cylindrical rolling elements 24 disposed between the inner and outer rings 20, 22. The inner ring 20 has an inner circumferential surface 21 frictionally engaged with the shaft 1 and the outer ring 22 has an outer circumferential surface 23 frictionally engaged with the housing 2. As such, radial loading RL is transferred directly between the shaft 1 and the housing 2 through the inner ring 20, the rolling elements 24 and the outer ring 22. Preferably, the cylindrical rolling elements 24 are conventional rollers as depicted in FIG. 1-5, but may alternatively be formed as needles (not shown).

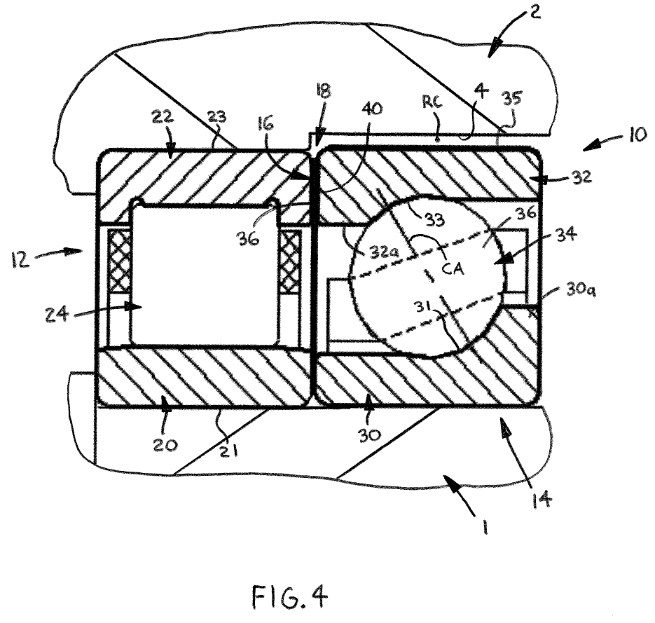

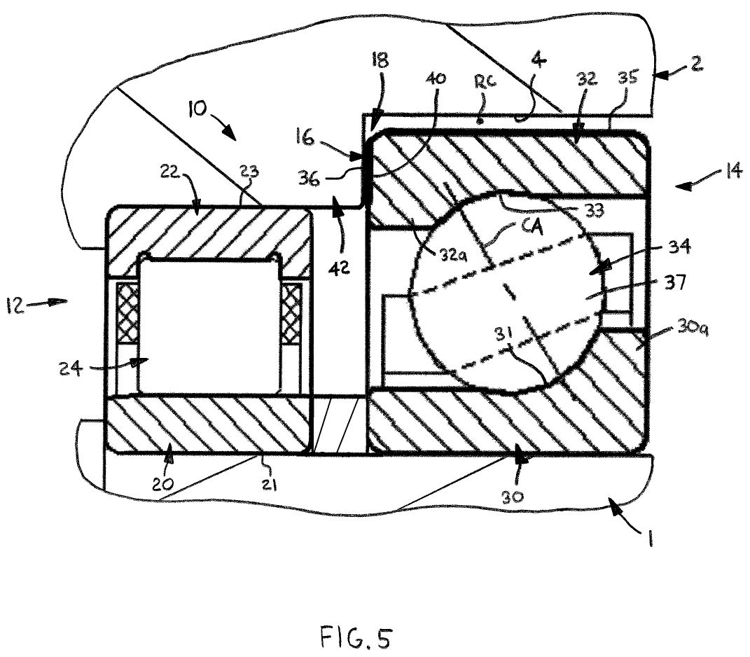

Further, the axial load bearing 14 includes an inner ring 30 disposed about the shaft 1, an outer ring 32 disposed about the inner ring 30, and a plurality of rolling elements 34 disposed between the inner and outer rings 30, 32, respectively. The outer ring 32 has an axial surface 36 on one axial end (not indicated) that is disposed against an axial surface 40 of a transfer member 42 so as to define the axial interface 18. In a presently preferred construction, the transfer member 42 is a spacer ring 50 disposed between the outer ring 22 of the radial load bearing 12 and the outer ring 32 of the axial load bearing 14, as shown in FIGS. 1-3, an inner spacer ring 52 preferably being disposed between the inner rings 30, 40 of the two bearings 12, 14. However, the transfer member 42 may alternatively be provided by the outer ring 22 of the radial load bearing 12, as depicted in FIG. 4, or a portion of the housing 2, such as an annular shoulder, a frame member, etc., as shown in FIG. 5. Regardless of the specific component providing the transfer member 42, axial loading AL is transferred between the shaft 1 and the housing 2 through the axial interface 18.

Furthermore, the layer of friction reducing material 16 is formed on at least one of the two axial surfaces 36, 40 defining the axial interface 18 so as to reduce a coefficient of friction of the interface 18. As a result, any frictional force generated by a normal force between the two surfaces 36, 40, which is the axial loading AL transferred through the axial interface 18 and/or a preload PL as discussed below, is reduced to a negligible magnitude. More specifically, axial loading AL on the shaft 1 passes through the axial load bearing 14, and preferably through at least one more axial load bearing 60 as described below, so as to be transferred from the outer ring 32 of the axial load bearing 14 to the housing 2 through the transfer member 42. The axial loading AL thereby produces the normal force within the interface 18.

In the absence of the layer of friction reducing material 16, each axial surface 36, 40 is in direct contact and are each formed of a metallic material, for example, bearing steel and low carbon steel. The coefficient of friction between these directly contacting surfaces 36, 40 may be sufficiently large that the friction force resulting from the applied normal force frictionally couples, at least temporarily, the outer ring 32 of the axial load bearing 14 with the transfer member 42. As there is radial clearance between the rolling elements 24 and the inner and outer rings 20, 22 of the radial load bearing 12, the frictional coupling of the outer ring 32 and the transfer member 42 causes radial loading RL to be transferred through the axial load bearing 14 to the housing 12. As the axial load bearing 14 is not constructed for supporting radial loads, the transfer of radial loading RL through the axial load bearing 14 may ultimately lead to damage or at least premature wear in the axial load bearing 14, and therefore reduce the life of the bearing 14. Also, as the radial load bearing 12 may require a minimum amount of radial loading to prevent skidding of the rollers 24, the transfer of the radial loading RL through the axial load bearing 14, instead of the radial load bearing 12, may adversely affect the operation of the radial load bearing 12.

Therefore, by providing at least one layer of friction reducing material 16 in the axial interface 18, the resulting friction force of negligible magnitude does not frictionally couple the outer ring 32 with the transfer member 42. In other words, the friction reducing layer 16 is configured to prevent frictional coupling of the outer ring 32 of the axial load bearing 14 with the transfer member 42. Instead, the outer ring 32 of the axial load bearing 14 is slidable radially against the transfer member 42 so as to displace radially, along with the remainder of the bearing 14, when a radial load RL is applied to the bearing assembly 10. As such, the axial and radial loads of the bearing assembly 10 are separated such that all radial loading RL is transferred between the shaft 1 and the housing 2 only through the radial load bearing 12 while only axial loading AL is supported by the axial load bearing 14. Further, as a radial clearance RC is defined between an outer circumferential surface 35 of the outer ring 32 and an inner circumferential surface 4 of the housing 2, the axial load bearing 14 is freely radially displaceable relative to the housing 2.

Further, the layer of friction reducing material 16 is preferably either a surface treatment or a coating. More specifically, when the layer 16 is provided by a surface treatment, the treatment is preferably formed by a black oxidation process conducted on one or both axial surfaces 36, 40 of the axial interface 18. When the layer 16 is provided by a coating, the coating is preferably formed of a polymeric material, most preferably polytetrafluoroethylene (“PTFE”) or a diamond-like carbon (“DLC”) applied to at least one of axial surfaces 36, 40 of the axial interface 18 by any appropriate process, e.g., dipping, painting, etc. Furthermore, the layer of friction reducing material 16 has an axial thickness within the range of one micron and fifty microns, preferably within the range of five microns and fifteen microns. Also, although the layer of friction reducing material 16 is necessarily applied to at least one of the two surfaces 36, 40 of the axial interface 18, the layer 16 may be applied to entire axial load bearing 14 and/or the entire radial bearing 12 or transfer member 42, or any other desired portions of any of these components.

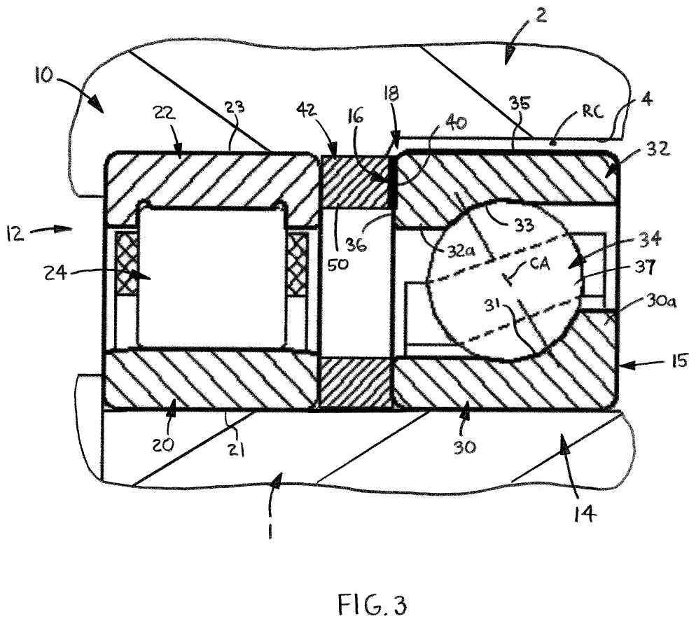

Referring now to FIGS. 3-5, the axial load bearing 14 is preferably an angular contact ball bearing 15 in which the inner ring 30 has a radially-outwardly extending shoulder 30a providing an axial portion of an inner raceway 31, the outer ring 32 has a radially-inwardly extending shoulder 32a providing an axial portion of an inner raceway 33, and the rolling elements 34 are balls 37. With this structure, the balls 37 contact the inner and outer rings 30, 32 at a contact angle CA with respect to the central axis A_{C}, such that axial loading is transferred from the inner ring 30 to the outer ring 32 and vice-versa. Alternatively, the axial load bearing 14 may alternatively be formed as a deep groove ball bearing, a tapered roller bearing, a four-point contact bearing, etc.

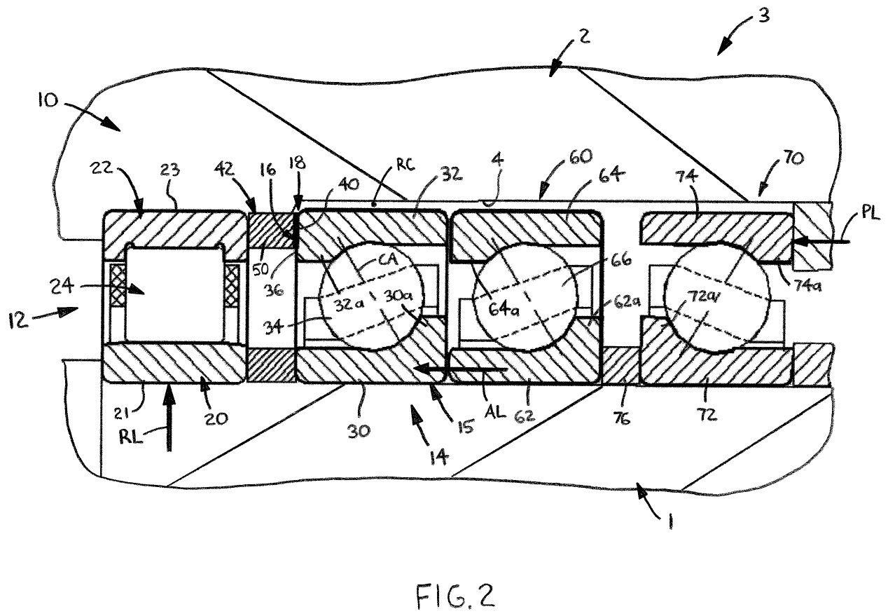

Referring to FIGS. 1 and 2, most preferably, the axial load bearing 14 is a first angular contact ball bearing 15 and the bearing assembly 10 further comprises at least a second angular contact ball bearing 60, such that the axial loading AL is shared equally among the first and second angular contact ball bearings 15, 60. Specifically, the second angular contact ball bearing 60 includes an inner ring 62 disposed about the shaft 1, an outer ring 64 disposed about the inner ring 62 and a plurality of balls 66 disposed between the inner and outer rings 62, 64. The inner ring 62 of the second angular contact bearing 60 is disposed axially against the inner ring 30 of the first angular contact ball bearing 15 and the outer ring 64 is disposed axially against the outer ring 32 of the first angular contact ball bearing 15, the two rings 62, 64 of the second bearing 64 having annular shoulders 62a, 64a arranged in the same orientation as the first bearing 15. With this arrangement, axial loading AL on the shaft 1 is transferred through the second angular contact bearing 60 and through the first angular contact bearing 15 to the transfer member 42, the axial loading AL being distributed equally between the first and second angular contact ball bearings 15, 60.

In a presently preferred application, the bearing assembly 10 further comprises a third angular contact ball bearing 70 arranged axially outwardly of the second angular contact bearing 60 and preferably arranged in an inverse orientation with respect to the first and second angular contact ball bearings 15, 60. That is, the third angular contact ball bearing 70 has an inner ring 72 with an annular shoulder 72a and an outer ring 74 with an annular shoulder 74a that are oriented such that the second and third angular contact ball bearings 60, 70 are arranged face-to-face. However, the inner rings 62, 72 of the second and third angular contact ball bearings 60, 70 are preferably separated by a spacer ring 76 disposed about the shaft 1.

As shown in FIG. 1, the bearing assembly 10 preferably further comprises a preload assembly 80 configured to apply an axial preload PL to the axial load bearing 14, which is transferred from the assembly 80 through the second and third angular contact ball bearings 60, 70. The axial preload PL maintains contact between the axial surface 36 of the outer ring 32 of the axial load bearing 14 and the other axial surface 40 defining the axial interface 18 when there is no axial loading on the shaft 1. Preferably, the preload assembly 80 includes an annular contact member 82 with an axial end 82a disposed against the outer ring 74 of the third angular contact ball bearing 70 and a plurality of biasing members 84, preferably helical compression springs, extending between the housing 2 and the contact member 82. With this structure, the biasing members 84 bias the contact member 82 against the outer ring 74 of the third angular contact ball bearing 70 with a certain amount of force that is transferred through the third and second bearings 70, 60 to the outer ring 32 of the first axial load bearing 14 so as the establish the preload PL within the axial interface 18.

Although the presently preferred application of the bearing assembly 10 as described above includes three angular contact ball bearings 15, 70 and 80 and the preload assembly 80 as described above, the bearing assembly 10 of the present invention may include any number of axial load bearings 14 formed and/or arranged in any other appropriate manner and/or have any other means for establishing a preload. For example, the axial load bearing 14 may be provided by a single deep groove ball bearing, two angular contact ball bearings, four angular contact bearings, two tapered roller bearings, etc.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A bearing assembly for rotatably coupling a shaft with an outer housing, the bearing assembly comprising:
a radial load bearing configured to support radial loading between the shaft and the housing and including an inner ring disposed about the shaft, an outer ring disposed about the inner ring and engaged with the housing, and a plurality of cylindrical rolling elements disposed between the inner and outer rings; and
an axial load bearing configured to support axially loading on at least one of the shaft and the housing and including an inner ring disposed about the shaft, an outer ring disposed about the inner ring, and a plurality of rolling elements disposed between the inner and outer rings, the outer ring having an axial surface disposed against an axial surface of a transfer member so as to define an axial interface, the transfer member being one of a spacer ring disposed between the radial load bearing and the axial load bearing, the outer ring of the radial load bearing, and a portion of the housing;
wherein a layer of friction reducing material is formed on at least one of the two axial surfaces defining the axial interface so as to reduce a coefficient of friction of the axial interface.

2. The bearing assembly as recited in claim 1, wherein axial loading is transferred between the shaft and the housing through the axial interface.

3. The bearing assembly as recited in claim 2, wherein axial loading on the shaft is transferred from the outer ring of the axial load bearing to the housing through the transfer member.

4. The bearing assembly as recited in claim 1, wherein the outer ring of the axial load bearing is slidable radially against the transfer member.

5. The bearing assembly as recited in claim 4, wherein the outer ring of the axial load bearing displaces radially when a radial load is applied to the bearing assembly such that the radial load is transferred between the shaft and the housing through the radial load bearing.

6. The bearing assembly as recited in claim 5, wherein a radial clearance is defined between an outer circumferential surface of the outer ring of the axial load bearing and an inner circumferential surface of the housing.

7. The bearing assembly as recited in claim 1, wherein the friction reducing layer is configured to prevent frictional coupling of the outer ring of the axial load bearing with the transfer member.

8. The bearing assembly as recited in claim 1, wherein the layer of friction reducing material is a surface treatment or a coating.

9. The bearing assembly as recited in claim 8, wherein:
the surface treatment is formed by a black oxidation process on the at least one axial surface of the axial interface; or
the coating is formed of a polymeric material or a diamond-like coating applied to the at least one axial surface of the axial interface.

10. The bearing assembly as recited in claim 1, wherein the layer of friction reducing material has a thickness within the range of one micron and fifty microns.

11. The bearing assembly as recited in claim 1, wherein the axial load bearing is an angular contact ball bearing.

12. The bearing assembly as recited in claim 11, wherein the axial load bearing is a first angular contact ball bearing and the bearing assembly further comprises a second angular contact ball bearing including an inner ring disposed about the shaft and axially against the inner ring of the first angular contact ball bearing, an outer ring disposed axially against the outer ring of the first angular contact ball bearing and a plurality of balls disposed between the inner and outer rings of the second angular contact ball bearing such that axial loading on the shaft is transferred through the second angular contact bearing and through the first angular contact bearing to the transfer member.

13. The bearing assembly as recited in claim 1, further comprising a preload assembly configured to apply an axial preload to the axial load bearing so as to maintain contact between the axial surface of the outer ring of the axial load bearing and the axial surface of the transfer member.

14. A bearing assembly for rotatably coupling a shaft with an outer housing, the bearing assembly comprising:
a radial load bearing configured to support radial loading between the shaft and the housing and including an inner ring disposed about the shaft, an outer ring disposed about the inner ring and engaged with the housing, and a plurality of cylindrical rolling elements disposed between the inner and outer rings;
an axial load bearing configured to support axially loading on at least one of the shaft and the housing and including an inner ring disposed about the shaft, an outer ring disposed about the inner ring, and a plurality of rolling elements disposed between the inner and outer rings; and
a spacer ring disposed between the outer ring of the radial load bearing and the outer ring of the axial load bearing, the outer ring of the axial load bearing having an axial surface disposed against an axial surface of the spacer ring so as to define an axial interface;
wherein a layer of friction reducing material is formed on at least one of the two axial surfaces defining the axial interface so as to reduce a coefficient of friction of the axial interface.

15. The bearing assembly as recited in claim 14, wherein axial loading is transferred between the shaft and the housing through the axial interface.

16. The bearing assembly as recited in claim 14, wherein the outer ring of the axial load bearing is slidable radially against the spacer ring such that the outer ring of the axial load bearing displaces radially when a radial load is applied to the bearing assembly so that the radial load is transferred between the shaft and the housing through the radial load bearing.

17. The bearing assembly as recited in claim 14, wherein the friction reducing layer is configured to prevent frictional coupling of the outer ring of the axial load bearing with the spacer ring.

18. The bearing assembly as recited in claim 14, wherein the layer of friction reducing material is a surface treatment formed by a black oxidation process on the at least one axial surface of the axial interface or a coating is formed of a polymeric material or a diamond-like coating applied to the at least one axial surface of the axial interface.

19. The bearing assembly as recited in claim 14, wherein the layer of friction reducing material has a thickness within the range of one micron and fifty microns.

20. The bearing assembly as recited in claim 14, wherein the axial load bearing is an angular contact ball bearing.
